(19) United States
(12) Patent Application Publication
(10) Pub. No.: US 2022/0086103 A1
(43) Pub. Date: Mar. 17, 2022

(54) NETWORK BANDWIDTH ADJUSTMENT METHOD AND RELATED PRODUCT

(71) Applicant: Shanghai SenseTime Intelligent Technology Co., Ltd., Shanghai (CN)

(72) Inventors: Lei LU, Shanghai (CN); Peng SUN, Shanghai (CN)

(21) Appl. No.: 17/538,830

(22) Filed: Nov. 30, 2021

Related U.S. Application Data
(63) Continuation of application No. PCT/CN2021/079382, filed on Mar. 5, 2021.

(30) Foreign Application Priority Data
Mar. 27, 2020 (CN) 202010228648.X

(51) Int. Cl. H04L 47/70

(52) U.S. Cl. CPC H04L 47/82; G06N 20/00

(57) ABSTRACT

Methods, systems, apparatus, and computer-readable storage media for adjusting network bandwidths are provided. In one aspect, a method includes: obtaining time information for a work node completing at least one training iteration during a training task; in response to determining, based on the time information, that the at least one training iteration is overtime, sending a bandwidth update request to a first server, where the bandwidth update request indicates a request for the first server to update a bandwidth of a service node which stores data of the training task.

### CROSS-REFERENCE TO RELATED APPLICATION

The present application is a continuation of International Application No. PCT/CN2021/079382 filed on Mar. 5, 2021, which claims a priority of the Chinese patent Application No. 202010228648.X filed on Mar. 27, 2020, which is incorporated herein by reference in its entirety.

### TECHNICAL FIELD

The present disclosure relates to the field of computers and in particular to methods of adjusting network bandwidths and related products.

### BACKGROUND

In a distributed deep learning training system, periodic synchronization may be performed on computation results of different computing nodes based on parameter aggregation. However, simultaneous data interaction between a plurality of computing nodes and a parameter server may lead to network congestion of a service node, thus affecting a training efficiency of an entire deep learning model.

### SUMMARY

Embodiments of the present disclosure provide methods of adjusting network bandwidths and related products.

According to a first aspect of embodiments of the present disclosure, a computer-implemented method of adjusting a network bandwidth is provided. The method includes: obtaining time information for a work node completing at least one training iteration during a training task; and in response to determining, based on the time information, that the at least one training iteration is overtime, sending a bandwidth update request to a first server, where the bandwidth update request indicates a request for the first server to update a bandwidth of a service node which stores data of the training task.

Optionally, before performing an N-th training iteration, the work node obtains a parameter for performing the N-th training iteration from the service node (e.g., server node). An execution subject in the embodiment of the present disclosure may be a second server. The second server may be one server cluster or one server. In some embodiments, the second server, the work node and the service node are included in a same distributed training cluster. The server node is a parameter server mainly for storing a parameter of a deep learning training task, receiving a gradient pushed by the work node and updating a local parameter. The work node obtains a parameter from the server node and pushes a gradient obtained through iterative computation to the server node. When the work node obtains the parameter from the server node and pushes the gradient to the server node, network congestion may occur to the server node, thereby resulting in loss of data in transmission. If network congestion occurs to the server node, when the work node obtains a parameter from the server node and pushes a gradient to the server node again, overtime will occur, thus affecting subsequent training process. In the embodiment of the present disclosure, the second server may detect a time length consumed by the work node for completing a training iteration each time in real time or close to real time, so as to determine whether each training iteration is overtime. In response to determining that a certain training iteration is overtime, the second server may accurately determine insufficiency of a current network bandwidth of the service node, so as to automatically adjust the network bandwidth of the service node. In the embodiment of the present disclosure, the second server may dynamically adjust the network bandwidth of the service node in real time to avoid training overtime of the work node and improve training efficiency.

In an embodiment of the present disclosure, in response to that the time consumed by the work node for completing at least one training iteration during the training task is overtime, a bandwidth update request is sent to the first server to update the network bandwidth of the service node. In this way, the problem of the network bandwidth insufficiency of the parameter server can be effectively solved, and the training efficiency of the work node can be improved.

In an optional implementation, the at least one training iteration includes N training iterations and determining that the at least one training iteration is overtime includes: based on a first time length consumed for the at least one training iteration and historical iteration time length information of the work node performing the training task, determining the at least one training iteration is overtime, where the first time length indicates a time consumed by the work node for completing an N-th training iteration of the N training iterations during the training task.

Because the work node performs a similar operation for each training iteration during the training task, the time length consumed by the work node for completing each training iteration during the training task is also basically same. A historical iteration time length record includes a time length consumed by the work node for completing at least one training iteration during the training task. Based on the first time length and the historical iteration time length record, whether the first time length is longer than a previous iteration time length can be accurately determined and thus whether completing at least one training iteration is overtime can be determined. In some embodiments, the first time length of the at least one training iteration is a time length for the N-th training iteration currently performed, and determining the at least one training iteration is overtime may be determining the N-th training iteration currently performed is overtime.

In this implementation, based on the first time length and historical iteration time length information, whether the time consumed by the work node for completing at least one training iteration is overtime may be accurately and quickly determined.

In an optional implementation, determining that the at least one training iteration is overtime includes: obtaining a second time length based on at least one time length consumed by the work node for completing at least one historical training iteration during the training task, where the second time length indicates an average time length consumed by the work node for completing the at least one historical training iteration during the training task; in response to determining that a difference between the first time length and the second time length is equal to or greater than a first time threshold, determining that the at least one training iteration is overtime.

In an optional implementation, determining that the at least one training iteration is overtime includes: based on the historical iteration time length information of the work node performing the training task, determining a maximum time length among time lengths consumed by the work node for completing first to (N-1)-th training iterations of the N training iterations; in response to that a difference between the first time length and the maximum time length is equal to or greater than a second time threshold, determining that the at least one training iteration is overtime.

In this implementation, whether the time consumed by the work node for completing at least one training iteration is overtime may be accurately and quickly determined.

In an optional implementation, at least one training iteration includes K continuous training iterations, and determining that the at least one training iteration is overtime includes: obtaining a third time length consumed by the work node for continuously completing the K continuous training iterations; obtaining an average time length consumed by the work node for continuously completing K historical training iterations of the training task; in response to that a difference between the third time length and the average time length is equal to or greater than a third time threshold, determining the at least one training iteration is overtime.

In this implementation, whether the time consumed by the work node for continuously completing multiple training iterations is overtime may be accurately and quickly determined.

In an optional implementation, the work node and the service node both are physical nodes.

In an optional implementation, the computer-implemented method of adjusting a network bandwidth is configured to be performed by a second server, where one of the work node and the service node is a virtual machine running on a third server, and the other one of the work node and the service node is a physical node or a virtual machine running on a fourth server.

In an optional implementation, the computer-implemented method of adjusting a network bandwidth is configured to be performed by a first virtual machine on a second server, where the second server is configured to further run a second virtual machine and a third virtual machine, the second virtual machine being functioned as the work node, the third virtual machine being functioned as the service node.

Optionally, the second server may be one server, or one cloud server, or one server cluster. Illustratively, the second server may be a computing node included in an OpenStack cloud platform system, and the first server is a control node included in the OpenStack cloud platform system.

In an optional implementation, the method further includes: before obtaining the time information, running a training task startup script to obtain a time length consumed by the work node to complete at least one training iteration during the training task.

In an optional implementation, the training task startup script includes at least one of information for determining whether the at least one training iteration is overtime or a preset bandwidth adjustment amplitude.

In an optional implementation, the method further includes: obtaining a current first bandwidth of the service node; determining to adjust the bandwidth of the service node to a second bandwidth based on the current first bandwidth and a preset bandwidth adjustment amplitude, where the second bandwidth is greater than the first bandwidth and is carried in the bandwidth update request.

According to a second aspect of embodiments of the present disclosure, an apparatus is provided. The apparatus includes: at least one processor; and one or more memories coupled to the at least one processor and storing programming instructions for execution by the at least one processor to perform operations including: obtaining time information for a work node completing at least one training iteration during a training task; and in response to determining, based on the time information, that the at least one training iteration is overtime; sending a bandwidth update request to a first server, where the bandwidth update request indicates a request for the first server to update a bandwidth of a service node which stores data of the training task.

In an optional implementation, the at least one training iteration includes N training iterations, and determining that the at least one training iteration is overtime includes: based on a first time length consumed by the at least one training iteration and historical iteration time length information of the work node performing the training task, determining the at least one training iteration is overtime, where the first time length indicates a time consumed by the work node for completing an N-th training iteration of the N training iterations during the training task.

In an optional implementation, determining that the at least one training iteration is overtime includes: obtaining a second time length based on at least one time length consumed by the work node for completing at least one historical training iteration during the training task, where the second time length indicates an average time length consumed by the work node for completing at least one historical training iteration during the training task; in response to determining that a difference between the first time length and the second time length is equal to or greater than a first time threshold, determining that the at least one training iteration is overtime.

In an optional implementation, determining that the at least one training iteration is overtime includes: based on the historical iteration time length information of the work node performing the training task, determining a maximum time length among time lengths consumed by the work node for completing the first to (N-1)-th training iterations of the N training iterations; in response to determining that a difference between the first time length and the third time length is equal to or greater than a second time threshold, determining that the at least one training iteration is overtime.

In an optional implementation, at least one training iteration includes K continuous training iterations and determining that the at least one training iteration is overtime includes: obtaining a third time length consumed by the work node for continuously completing the K training iterations; obtaining an average time length consumed by the work node for continuously completing K historical training iterations of the training task; and in response to determining that a difference between the third time length and the average time length is equal to or greater than a third time threshold, determining the at least one training iteration is overtime.

In an optional implementation, before obtaining the time information for the work node completing the at least one training iteration during the training task, the operations further includes: running a training task startup script to obtain a time consumed by the work node to complete the at least one training iteration during the training task.

In an optional implementation, the training task startup script includes at least one of information for determining whether the at least one training iteration is overtime or a preset bandwidth adjustment amplitude.

In an optional implementation, the operations further include: obtaining a current first bandwidth of the service node; and based on the current first bandwidth and a preset bandwidth adjustment amplitude, determining to adjust the bandwidth of the service node to a second bandwidth, where the second bandwidth is greater than the first bandwidth and is carried in the bandwidth update request.

According to a third aspect of embodiments of the present disclosure, a non-transitory computer readable storage medium is provided. The non-transitory computer readable storage medium coupled to at least one processor having machine-executable instructions stored thereon that, when executed by the at least one processor, cause the at least one processor to perform operations including: obtaining time information for a work node completing at least one training iteration during a training task; and in response to determining, based on the time information, that the at least one training iteration is overtime, sending a bandwidth update request to a first server, where the bandwidth update request indicates a request for the first server to update a bandwidth of a service node which stores data of the training task.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is an architecture schematic diagram illustrating a distributed training cluster according to an embodiment of the present disclosure.

FIG. 2 is an architecture schematic diagram illustrating another distributed training cluster according to an embodiment of the present disclosure.

FIG. 3 is an architecture schematic diagram illustrating a distributed training platform system according to an embodiment of the present disclosure.

FIG. 4 is a flowchart illustrating a method of adjusting a network bandwidth according to an embodiment of the present disclosure.

FIG. 5 is a flowchart illustrating another method of adjusting a network bandwidth according to an embodiment of the present disclosure.

FIG. 6 is a flowchart illustrating yet another method of adjusting a network bandwidth according to an embodiment of the present disclosure.

FIG. 7 is a structural schematic diagram illustrating an apparatus for adjusting a network bandwidth according to an embodiment of the present disclosure.

FIG. 8 is a structural schematic diagram illustrating a server according to an embodiment of the present disclosure.

### DETAILED DESCRIPTION OF THE EMBODIMENTS

The terms such as “first” “second” and “third” in the embodiments of the specification and the claims of the present disclosure and the above accompanying drawings are used to distinguish similar objects rather than describe a particular sequence or precedence. Furthermore, the terms such as “including” “having” and their variations are intended to cover non-exclusive inclusion, for example, include a series of steps or units. The methods, systems, products or devices are not limited to those steps or units clearly listed but include other steps or units not clearly listed or inherent to these processes, methods, products or devices. A plurality refers to two or more.

A method of adjusting a network bandwidth according to the embodiments of the present disclosure may be applied to a distributed training cluster. The distributed training cluster includes one scheduler node, one or more work nodes and one or more service nodes. The scheduler node is used to run a startup script of a training task, the work node is used to perform the training task and push a gradient obtained through training iteration to the server node, and the server node serving as a parameter server is mainly used to store a parameter of the training task, receive a gradient pushed by the work node and update a local parameter.

In some embodiments, the distributed training cluster for deep learning training may include one scheduler node, several work nodes and several service nodes. When the several work nodes obtain a parameter from the service node and push a gradient to the service node simultaneously, network congestion may occur to the service node, thus leading to loss of data in transmission. When the work nodes obtain a parameter from the service node or push a gradient to the service node again, overtime may occur, thus affecting subsequent training processes. Therefore, it is a key to guarantee a network bandwidth of the service node so as to complete a deep learning task smoothly.

Architectures of two distributed training clusters will be described below.

FIG. 1 is an architectural schematic diagram illustrating a distributed training cluster according to an embodiment of the present disclosure. As shown in FIG. 1, the distributed training cluster includes one scheduler node 101, one or more work nodes 102 and one or more service nodes (also called server nodes) 103. The scheduler node 101, the work node 102 and the service node 103 are all physical nodes, for example, servers. As shown in FIG. 1, the work node 102 is used to perform a training task and push a gradient obtained through a training iteration to the service node 103; the service node 103 serving as a parameter server is mainly used to store a parameter of the training task, receive a gradient pushed by the work node 102, and update a local parameter; the scheduler node 101 is used to run a startup script of the training task (e.g., a training task startup script), detect a time length in which the work node 102 performs each training iteration, and update a bandwidth of the service node 103 through a first server in response to that a time in which the work node 102 performs any one training iteration is overtime. In some embodiments, the training task startup script includes computer program codes used to implement the method of adjusting a network bandwidth according to the embodiments of the present disclosure, for example, the script includes program codes for implementing one or more functions such as polling each of the work nodes performing the training task to obtain the time length of one or more training iterations, determining training overtime and determining how to adjust a network bandwidth. In some embodiments, the training task startup script is further used to start up the training task or start up in response to startup of the training task.

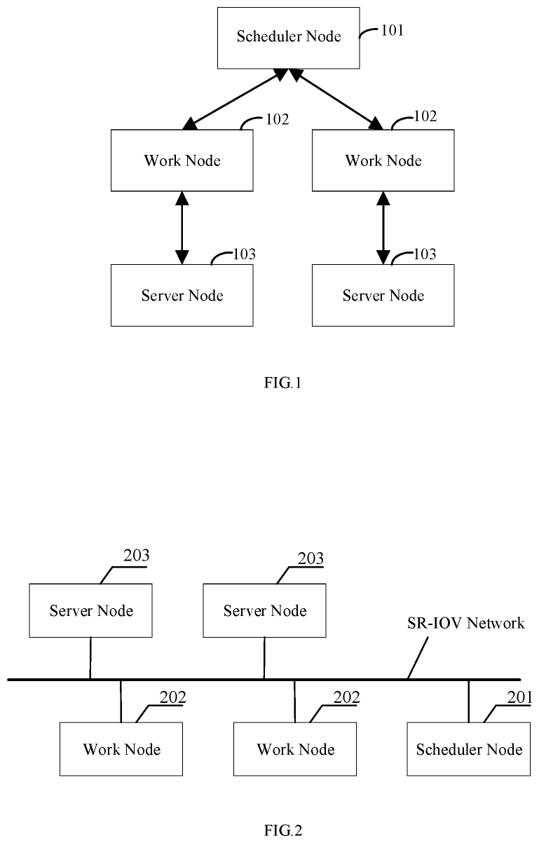

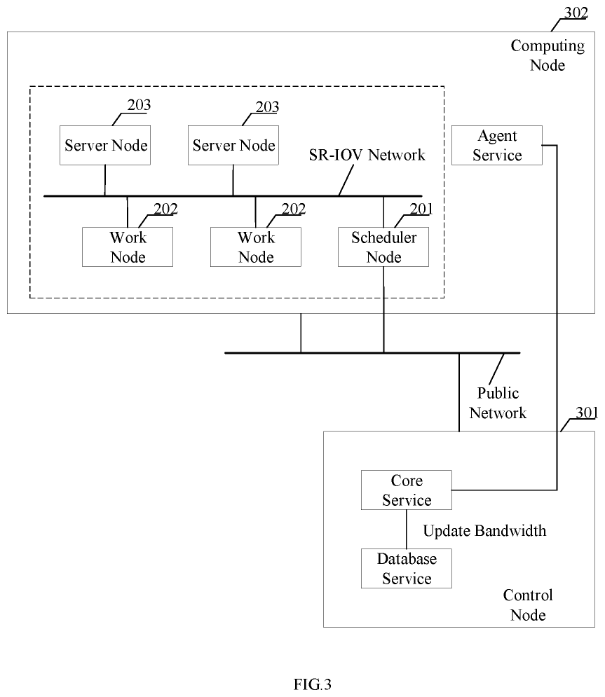

FIG. 2 is an architectural schematic diagram illustrating another distributed training cluster according to an embodiment of the present disclosure. As shown in FIG. 2, a scheduler node 201, a work node 202 and a service node 203 are all virtual machines. The scheduler node 201, the work node 202 and the service node 203 all perform data interaction through a private network obtained by single root I/O visualization (SR-IOV) technology, e.g., a SR-IOV network. Illustratively, the scheduler node 201, the work node 202 and the service node 203 may run on a same sever (corresponding to a second server) or a same server cluster. The scheduler node 201, the work node 202 and the service node 203 are all virtual machines under the management of an OpenStack platform. FIG. 3 is an architectural schematic diagram illustrating a distributed training platform system according to an embodiment of the present disclosure. As shown in FIG. 3, the distributed training platform system includes a control node 301 and a computing node 302 (corresponding to the distributed training cluster in FIG. 2). The control node 301 and the computing node 302 may interact with each other via a public network. The scheduler node 201 in the computing node 302 interacts with the control node 301 via a public network (e.g. internet). That is, the distributed training cluster in FIG. 2 includes a plurality of virtual machines managed by the OpenStack platform, e.g., the scheduler node 201, the work node 202 and the service node 203. Optionally, the work node 202 and the service node 203 only have a SR-IOV network card whereas the scheduler node 201 has a SR-IOV network card and an Ethernet card. When these nodes are created, corresponding network bandwidths are set on the SR-IOV network cards. Optionally, A network system service Neutron component of the OpenStack cloud platform is in charge of providing layer-2 and layer-3 networks to the virtual machines. The Neutron component includes services such as neutron-server service, neutron-database service and neutron-sriov-agent service. The control node (corresponding to a first server) provides the neutron-server service and the neutron-database service, and the computing node (corresponding to a second server) provides the neutron-sriov-agent service. As shown in FIG. 3, an agent service represents the neutron-sriov-agent service, a core service represents the neutron-server service, and a database service represents the neutron-database service. The three servers will be described below.

The neutron-server service: it is the core service of the OpenStack cloud platform system. This service is used to: receive a bandwidth update request; synchronize an updated network bandwidth value (corresponding to a second bandwidth) to a neutron database; send a Remote Procedure Call (RPC) request to call a specific neuron-sriov-agent to complete bandwidth update for the SR-IOV network card of the virtual machine (e.g., the service node).

The neutron-database service: the database service of the OpenStack cloud platform system is used to store the updated network bandwidth to ensure synchronization of all network-related data.

The neutron-sriov-agent service: the agent service of the SR-IOV type network of the OpenStack cloud platform system may be used to correct the network bandwidth of the SR-IOV network card of the server node in the distributed training cluster.

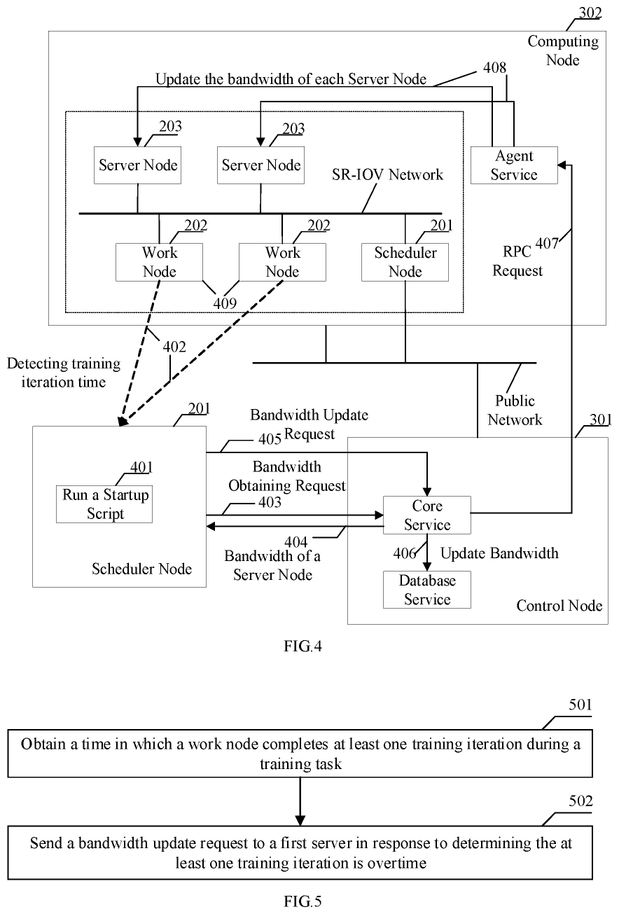

Operations performed by various nodes when the method of adjusting a network bandwidth according to the embodiments of the present disclosure is applied to the distributed training platform system shown in FIG. 3 will be described below. FIG. 4 is a flowchart illustrating a method of adjusting a network bandwidth according to an embodiment of the present disclosure. As shown in FIG. 4, the method may include the following steps.

At step 401, a scheduler node runs a startup script to start up a training task.

Illustratively, a command format of the training startup is [run_task work_ip1 work_ip2 server_ip1 server_ip2 timeout mult_size]. The command format indicates that there are two work nodes (e.g., work_ip1 and work_ip2) and two server nodes (e.g., server ip_1 and server_ip2); the timeout represents a maximum threshold (corresponding to a first time threshold) by which a current iteration time exceeds a previous average iteration time, and the mult_size represents a multiple for expanding the bandwidths of all current server nodes. It is understood that after the scheduler node runs the startup script to start up the training task, the work node obtains a parameter from the service node to perform the training task. Illustratively, the distributed training cluster includes a plurality of work nodes, each of which performs a part of the training task. Each work node obtains a parameter from the server node and pushes a gradient obtained through training iteration to the service node. The training task in the present disclosure may be a deep learning training task.

At step 402, the scheduler node detects a first time length in which a work node completes the N-th training iteration during the training task.

Illustratively, after triggering the startup script, the scheduler node may always poll each work node to obtain a time length of each training iteration for performing the training task and calculate, by accumulation, an average value (corresponding to a second time length) of the time lengths in which each work node performs several training iterations previously. That is, the scheduler node may detect a time in which the work node performs each training iteration. In some embodiments, the scheduler node may detect a time length in which each work node performs each training iteration, and record the time length in which each work node performs each training iteration to obtain a historical iteration time length record (also called historical iteration time length information) of each work node. If the scheduler node detects a first time length in which a certain work node completes the N-th training iteration during the training task, the first time length is recorded in the historical iteration time length record of the work node. In this case, the historical iteration time length record includes the time lengths in which the work node completes the first to N-th training iterations.

At step 403, in response to determining the time in which the work node completes the N-th training iteration during the training task is overtime, the scheduler node sends a bandwidth obtaining request to a control node.

Optionally, the bandwidth obtaining request is used to obtain a current bandwidth of each service node. Optionally, the scheduler node sends the bandwidth obtaining request to a network core service neutron-server of the OpenStack cloud platform in the control nodes. That is, the network core service neutron-server of the OpenStack cloud platform may obtain the bandwidth obtaining request. For example, there are two service nodes in the distributed training platform system in FIG. 3, and the bandwidth obtaining request is used to query network bandwidth values of the two service nodes. There are several manners to determine that the time in which the work node completes the N-th training iteration during the training task is overtime. In a first manner, the scheduler node may calculate an average value of the time lengths in which the work node completes the first to N-th training iterations to obtain the second time length, e.g., an iteration time average value; in response to that a difference between the first time length and the second time length is not smaller than a first time threshold (corresponding to the timeout), the scheduler node determines that the time in which the work node completes the N-th training iteration is overtime; the first time length is greater than the second time length. The second time length may also be an average time length in which the work node completes at least one historical training iteration during the training task. For example, when the N is equal to 5, the second time length may be an average value of the time lengths in which the work node completes the first to fourth training iterations. In a second manner, the scheduler node obtains a maximum time length of the time lengths in which the work node completes the first to (N-1)-th training iterations to obtain a third time length, where N is an integer greater than 1; in response to a difference between the first time length and the third time length is not smaller than a second time threshold (corresponding to the timeout), it is determined that the time in which the work node completes the N-th training iteration is overtime; the first time length is greater than the third time length. The overtime maximum threshold timeout may be configured by a user. In a third manner, the scheduler node may calculate a fourth time length in which the work node completes K training iterations continuously where K is an integer greater than 1; a fifth time length is obtained based on the time length of at least one training iteration, where the fifth time length is an average time length in which the work node completes K historical training iterations continuously; in response to that a difference between the fourth time length and the fifth time length is not smaller than a third time threshold (corresponding to the timeout), it is determined that the time in which the work node competes at least one training iteration during the training task is overtime. The fourth time length is greater than the fifth time length. The first time threshold, the second time threshold and the third time threshold all can be configurable by the user.

In some examples, it may be pre-agreed that different time thresholds are used for different training tasks. In some examples, the startup script may also include one parameter which indicates that the timeout corresponds to the first time threshold, the second time threshold or the third time threshold, such that the scheduler node can determine whether the work node is overtime based on the corresponding manner. In some examples, the timeouts corresponding to the first time threshold, the second time threshold and the third time threshold respectively are all notified to the scheduler node, and which manner is to be used to determine whether the work node is overtime is determined by script configuration or by the scheduler node. Optionally, the determination may be performed in any one of the above three manners. Optionally, the determination may be performed in several of the above three manners respectively. If one of the three manners shows overtime, it is determined that the work node is overtime. Optionally, the determination may be performed in several of the above three manners respectively. When at least two of the several manners show overtime, it is determined that the work node is overtime. The above is not limited in the present disclosure.

In response to determining the time in which the work node completes at least one training iteration during the training task is overtime, the scheduler node may determine the network bandwidth of the service node is insufficient. Once the startup script run by the scheduler node captures this situation, the scheduler node may send a bandwidth obtaining request to the network core service neutron-server of the OpenStack cloud platform in the control node to query a network bandwidth value of each service node. Then, the scheduler node sends a request to the neutron-server to update the network bandwidth value of the SR-IOV network card of each service node. The updated network bandwidth value is mult_size times of the original bandwidth value, where the mult_size is a real number greater than 1.

At step 404, the scheduler node obtains a current bandwidth of each service node.

Optionally, the scheduler node receives the current bandwidth of each service node from the network core service neutron-server.

At step 405, the scheduler node sends a bandwidth update request to the control node.

The bandwidth update request is used to request to update the bandwidth of each service node. Illustratively, the scheduler node sends the bandwidth update request to the network core service neutron-server of the OpenStack cloud platform in the control node. Illustratively, the current bandwidth of a certain service node is a first bandwidth, and the bandwidth update request is used to request the control node to update the bandwidth of the service node to a second bandwidth. Optionally, before performing the step 405, the scheduler node may perform the following operation: obtaining the updated bandwidth of each service node by calculating a product of the current bandwidth of each service node and the mult_size; generating the bandwidth update request based on the updated bandwidth of each service node. That is, the bandwidth update request carries the updated bandwidth of each service node. In some embodiments, the scheduler node obtains the first bandwidth of a certain service node, and determines a second bandwidth based on the first bandwidth and a preset bandwidth adjustment amplitude included in the script.

At step 406, the network core service neutron-server provided by the OpenStack cloud platform updates a new network bandwidth value of each service node to a database.

The new network bandwidth value refers to the updated bandwidth of each service node.

At step 407, the network core service neutron-server provided by the OpenStack cloud platform sends a Remote Procedure Call (RPC) request to a neutron-sriov-agent service on a computing node.

Optionally, the RPC request (corresponding to a bandwidth update instruction) is used to request the neuron-sriov-agent to complete bandwidth update for an SR-IOV network card of a virtual machine (e.g., the service node).

At step 408, the neuron-sriov-agent service on the computing node updates the bandwidth of each service node.

Illustratively, after receiving the RPC request (corresponding to the bandwidth update instruction), the neuron-sriov-agent service on the computing node may immediately call ip link set command to update the network bandwidth of the SR-IOV network card of each service node in sequence. It is understood that the updated bandwidth of the each service node is identical to each server-updated bandwidth indicated in the bandwidth update request sent by the scheduler node.

At step 409, the work node continues performing the training task until the training task is completed.

In the embodiments of the present disclosure, the network bandwidth of the parameter server in the distributed training cluster can be dynamically adjusted in real time without need for manual operations. In this way, the overtime of the iteration processes of the distributed training task resulting from the network bandwidth of the parameter server in the distributed training cluster can be avoided, thus promoting smooth completion of the deep learning task.

FIG. 5 is a flowchart illustrating a method of adjusting a network bandwidth according to an embodiment of the present disclosure. As shown in FIG. 5, the method may include the following steps.

At step 501, a time in which a work node completes at least one training iteration during a training task is obtained.

In some embodiments of the present disclosure, an execution subject is a second server which runs a first virtual machine, a second virtual machine and a third virtual machine. The second virtual machine is the above work node, and the third virtual machine is the above service node. The second server may be one server or one server cluster. In this embodiment, determining the time in which the work node completes at least one training iteration during the training task is overtime may be as follows: the first virtual machine (corresponding to the scheduler node) determines the time in which the work node (corresponding to the second virtual machine) completes at least one training iteration during the training task is overtime.

In some embodiments, the execution subject may be a second server (corresponding to the scheduler node). The work node and the service node both are physical nodes; or, one of the work node and the service node is a virtual machine running on a third server, and the other of the work node and the service node is a physical node or a virtual machine running on a fourth server. The virtual machine is a simulator of a computer system, which can simulate, through software, a complete computer system having complete hardware system functions and running in a fully-isolated environment to provide functions of a physical computer. That is, one virtual machine is one physical computer for other devices, e.g., one physical node. It should be understood that the scheduler node can implement the method of FIG. 5 to adjust the bandwidth of the service node regardless of the fact that the work node, the service node and the scheduler node are physical nodes or virtual machines.

At step 502, a bandwidth update request is sent to a first server in response to determining the at least one training iteration is overtime.

The bandwidth update request is used to request the first server to update a bandwidth of a service node; the above service node stores data of the above training task.

In some embodiments, after the second server sends the bandwidth update request to the first server, the method further includes: receiving, by the second server, a bandwidth update instruction from the first server; updating, by the second server, the bandwidth of the above service node from a first bandwidth to a second bandwidth based on the bandwidth update instruction. Illustratively, after the neutron-sriov-agent in the second server receives the bandwidth update instruction from the neutron-server in the first server (corresponding to the control node), the neutron-sriov-agent calls the ip link set command to update the network bandwidth of the SR-IOV network card of each service node in sequence. For example, the network bandwidth of the SR-IOV network card of each service node is expanded by mult_size times.

In an embodiment of the present disclosure, in response to that the time in which the work node completes at least one training iteration during the training task is overtime, the bandwidth update request is sent to the first server so as to update the bandwidth of the service node. This way, the problem of insufficient network bandwidth of the parameter server can be effectively solved, thereby avoiding training overtime of the work node.

A manner in which it is determined that the time in which the work node completes the N-th training iteration during a training task is overtime will be detailed below.

In an optional implementation, before performing the step 501, the second server may obtain a first time length in which the work node completes the N-th training iteration. The second server may determine the time in which the work node completes the N-th training iteration during the training task is overtime in the following manner: based on the first time length and a historical iteration time length record of the work node, the scheduler node determines the time in which the work node completes the N-th training iteration is overtime, that is, the time in which the work node completes N training iterations is overtime; the historical iteration time length record includes a time length in which the work node completes at least one training iteration during a training task. The scheduler node may be the second server or the first virtual machine running on the second server.

Illustratively, the historical iteration time length record includes the time lengths in which the work node completes the first to the N-th training iterations during the above training task; the scheduler node calculates an average value of the time lengths in which the work node completes the first to the N-th training iterations to obtain a second time length; in response to that a difference between the first time length and the second time length is not smaller than a first time threshold, the scheduler node determines that the time in which the work node completes the N-th training iteration is overtime; the first time length is greater than the second time length.

Illustratively, the historical iteration time length record includes the time lengths in which the work node completes the first to the N-th training iterations during the above training task; the scheduler node obtains a maximum time length of the time lengths in which the work node completes the first to (N-1)-th training iterations to obtain a third time length, where N is an integer greater than 1; in response to that a difference between the first time length and the third time length is not smaller than a second time threshold, the scheduler node determines that the time in which the work node completes the N-th training iteration is overtime; the first time length is greater than the third time length.

In this implementation, based on the first time length and the historical iteration time length record, whether the time in which the work node completes the N-th training iteration is overtime may be accurately and quickly determined.

In an optional implementation, before performing step 501, the second server may obtain a fourth time length in which the work node completes K training iterations continuously, where K is an integer greater than 1; a fifth time length is obtained based on the time length of at least one training iteration, where the fifth time length is an average time length in which the work node completes K historical training iterations continuously. Based on the above, determining that the time in which the work node completes at least one training iteration during the training task is overtime may be as follows: in response to that a difference between the fourth time length and the fifth time length is not smaller than a third time threshold, it is determined that the time in which the work node completes at least one training iteration during the training task is overtime; the fourth time length is greater than the fifth time length. In some embodiments, it is assumed that K=3 and the work node has completed 12 training iterations for the training task. In this case, in order to determine whether the time in which the work node completes K training iterations continuously is overtime, a fourth time length D in which the work node completes the 10th to 12th training iterations continuously is obtained, and an average time length in which the work node completes 3 historical training iterations continuously is obtained based on a time A in which the work node completes the 1st to 3rd training iterations continuously, a time B in which the work node completes the 4th to 6th training iterations continuously, a time C in which the work node completes the 7th to 9th training iterations continuously, and the fourth time length D. Therefore, the fifth time length may be obtained by dividing a sum of A, B, C and D by 4. If a difference between the fourth time length and the fifth time length is equal to or greater than a third time threshold, it is determined that the time in which the work node completes K training iterations continuously is overtime.

In this implementation, whether the time in which the work node completes K training iterations continuously is overtime can be accurately and quickly determined.

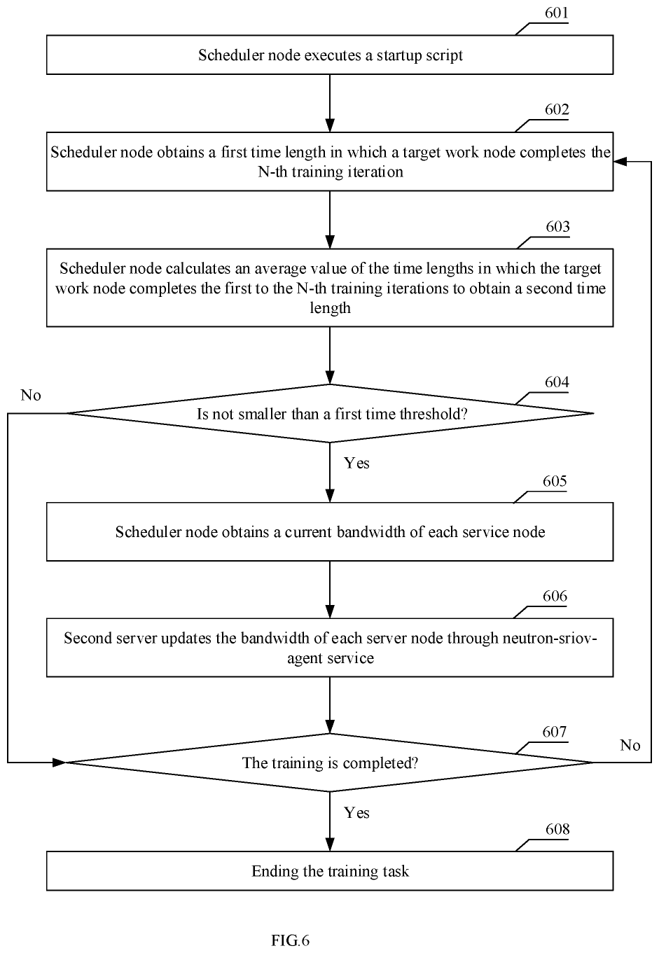

FIG. 6 is a flowchart illustrating another method of adjusting a network bandwidth according to an embodiment of the present disclosure. The method of FIG. 6 is further refined and improved based on the method of FIG. 5. The method of FIG. 6 is applied to the distributed training platform system of FIG. 3. As shown in FIG. 6, the method may include the following steps.

At step 601, a scheduler node executes a startup script. The startup script is used to obtain a time in which a work node completes at least one training iteration during a training task.

The scheduler node may be a first virtual machine running on a second server. Optionally, the scheduler node may execute the startup script to start algorithm training and query a training iteration time of each work node at the same time, and also determine whether the iteration time of each work node is overtime. The script includes at least one of information required to determine the at least one training iteration is overtime or a preset bandwidth adjustment amplitude.

At step 602, the scheduler node obtains a first time length in which a target work node completes the N-th training iteration.

The target work node may be any one work node in FIG. 2 or 3. In an actual application, the scheduler node may obtain the time length in which one or more work nodes complete each training iteration. In the embodiments of the present disclosure, the flow of the method of adjusting a bandwidth of a service node is described based on the target work node.

At step 603, the scheduler node calculates an average value of the time lengths in which the target work node completes the first to the N-th training iterations to obtain a second time length.

At step 604, the scheduler node determines whether a difference between the first time length and the second time length is not smaller than a first time threshold (corresponding to timeout).

If yes, step 605 is performed; if not, step 607 is performed. It is assumed that the first time length is 12ms, the second time length is 6ms, and the first time threshold is 5ms. In this case, the difference between the first time length and the second time length is 6ms, and the difference between the first time length and the second time length is not smaller the first time threshold.

At step 605, the scheduler node obtains a current bandwidth of each service node.

Illustratively, the service node may be a virtual machine running on the second server, e.g., the service node in FIG. 3. In some embodiments, optionally, the scheduler node sends a bandwidth obtaining request to a first server, where the bandwidth obtaining request is used to obtain the current bandwidth of each service node; the scheduler node receives the current bandwidth of each service node from the network core service neutron-server.

At step 606, the second server updates the bandwidth of each service node through neutron-sriov-agent service.

The implementation of the step 606 may be referred to the manner in which the neutron-sriov-agent updates the bandwidth of each service node in FIG. 4 and thus will not be repeated herein. The second server may be a computing node.

At step 607, the scheduler node determines whether the training is completed.

If yes, step 608 is performed; if not, step 602 is performed.

At step 608, the training task is ended.

An apparatus for adjusting a network bandwidth, which can implement the method of adjusting a network bandwidth according to the preceding embodiments, will be described below.

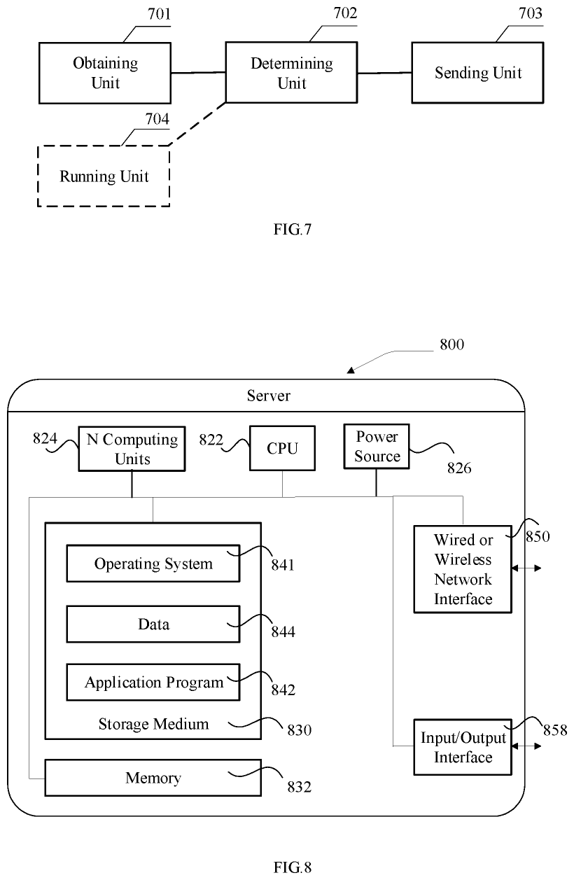

FIG. 7 is an apparatus for adjusting a network bandwidth according to an embodiment of the present disclosure. As shown in FIG. 7, the apparatus includes: an obtaining unit 701, configured to obtain a time in which a work node completes at least one training iteration during a training task; a determining unit 702, configured to determine the at least one training iteration is overtime; and a sending unit 703, configured to, in response to determining the at least one training iteration is overtime, send a bandwidth update request to a first server, where the bandwidth update request is used to request the first server to update a bandwidth of a service node; the service node stores data of the training task.

In an optional implementation, at least one training iteration refers to N training iterations, and the determining unit 702 is specifically configured to determine the at least one training iteration is overtime based on a first time length of the at least one training iteration and historical iteration time length information of performing the training task by the work node, where the first time length is a time in which the work node completes the N-th training iteration of the N training iterations during the training task.

In an optional implementation, the determining unit 702 is specifically configured to: obtain a second time length based on a time length in which the work node completes at least one historical training iteration during the training task, where the second time length is an average time length in which the work node completes at least one historical training iteration during the training task; in response to that a difference between the first time length and the second time length is equal to or greater than a first time threshold, determine the at least one training iteration is overtime.

In an optional implementation, the determining unit is specifically configured to: obtain a maximum time length of the time lengths in which the work node completes the first to (N-1)-th training iterations of the N training iterations based on the historical iteration time length information of performing the training task by the work node; determine the maximum time length as a third time length; in response to that a difference between the first time length and the third time length is equal to or greater than a second time threshold, determine the at least one training iteration is overtime.

In an optional implementation, the at least one training iteration refers to K continuous training iterations, and the determining unit 702 is specifically configured to: obtain a fourth time length in which the work node completes the K training iterations continuously; obtain an average time length in which the work node completes K historical training iterations of the training task continuously and determine the average time length as a fifth time length; in response to that a difference between the fourth time length and the fifth time length is equal to or greater than a third time threshold, determine the at least one training iteration is overtime.

In an optional implementation, the work node and the service node both are physical nodes; or, the method of adjusting a network bandwidth is applied to a second server, one of the work node and the service node is a virtual machine running on a third server, and the other of the work node and the service node is a physical node or a virtual machine running on a fourth server.

In an optional implementation, the method of adjusting a network bandwidth is applied to a first virtual machine on a second server, the second server further runs a second virtual machine and a third virtual machine, the second virtual machine is the work node, and the third virtual machine is the service node.

In an optional implementation, the apparatus further includes a running unit 704 which is configured to run a training task startup script before the obtaining unit obtains the at least one training iteration, where the training task startup script is used to obtain the time in which the work node completes at least one training iteration during the training task.

In an optional implementation, the training task startup script includes at least one of information required to determine the at least one training iteration is overtime or a preset bandwidth adjustment amplitude.

In an optional implementation, the obtaining unit 701 is further configured to obtain a current first bandwidth of the service node; the determining unit 702 is further configured to determine to adjust a bandwidth of the service node to a second bandwidth based on the first bandwidth and the preset bandwidth adjustment amplitude, where the bandwidth update request carries the second bandwidth and the second bandwidth is greater than the first bandwidth.

It should be understood that various units of the above apparatus for adjusting a network bandwidth are merely divided based on logic functions. In an actual implementation, these units may be wholly or partially integrated into one physical entity or physically separated. For example, the above units may be separate units or integrated into one chip. Furthermore, these units may also be stored in a storage element of a controller in the form of program codes and a particular processing element of a processor invokes and executes the functions of the above units. These units may be integrated together or implemented separately. The processing element herein may be an integrated circuit chip having signal processing capability. In an implementation process, various steps or units of the above method may be implemented by an integrated logic circuit of hardware in the processor element or by instructions of software form. The processing element may be a general processor, for example, a central processing unit (CPU), or may be configured as one or more integrated circuits for implementing the above method, for example, one or more application-specific integrated circuits (ASIC) or one or more digital signal processors (DSP), or one or more field-programmable gate arrays (FPGA) or the like.

FIG. 8 is a structural schematic diagram illustrating a server according to an embodiment of the present disclosure. The server 800 may have significant difference due to different configurations or performances, and may include one or more CPUs 822 (e.g. one or more processors), N computing units 824, a memory 832, one or more storage mediums 830 (e.g. one or more mass storage devices) storing an application program 842 or data 844. The memory 832 and the storage medium 830 may be transitory storage or permanent storage. Programs stored in the storage medium 830 may include one or more modules (not shown), and each module may include a series of instruction operations for a server. Furthermore, the CPU 822 may be configured to communicate with the storage medium 830. A series of instruction operations in the storage medium 830 are performed on the server 800. The server 800 may be the apparatus for adjusting a network bandwidth in the present disclosure.

The server 800 may further include one or more power sources 826, one or more wired or wireless network interfaces 850, one or more input/output interfaces 858, and/or, one or more operating systems 841, for example, Windows Server™, Mac OS X™, Unix™, Linux™, FreeBSD™ and the like.

The steps executed by the second server in the above embodiment may be based on the structure of the server shown in FIG. 8. Specifically, the CPU 822 may achieve the functions of the units in FIG. 7.

An embodiment of the present disclosure provides a computer readable storage medium storing computer programs. The above computer programs are executed by a processor to: in response to determining a time in which a work node completes at least one training iteration during a training task is overtime, send a bandwidth update request to a first server, where the bandwidth update request is used to request the first server to update the bandwidth of a service node, and the service node is a node storing data required by the work node to perform a training iteration task. The computer readable storage medium includes a non-transitory computer readable storage medium.

An embodiment of the present disclosure provides a computer program product including instructions. When running on a computer, the computer program product enables the computer to implement the method of adjusting a network bandwidth according to the above embodiments.

The above descriptions are merely specific embodiments of the present disclosure, and the scope of protection of the present disclosure is not limited to these embodiments. Various equivalent modifications or replacements thought of by those skilled in the art within the technical scope of the present disclosure shall all fall within the scope of protection of the present disclosure. Therefore, the scope of protection of the present disclosure is indicated in the appended claims.

1. A computer-implemented method of adjusting a network bandwidth, comprising:
obtaining time information for a work node completing at least one training iteration during a training task; and
in response to determining, based on the time information, that the at least one training iteration is overtime, sending a bandwidth update request to a first server, wherein the bandwidth update request indicates a request for the first server to update a bandwidth of a service node which stores data of the training task.

2. The computer-implemented method of claim 1, wherein the at least one training iteration comprises N training iterations, and
wherein determining that the at least one training iteration is overtime comprises:
based on a first time length consumed for the at least one training iteration and historical iteration time length information of the work node performing the training task, determining the at least one training iteration is overtime, wherein the first time length indicates a time consumed by the work node for completing an N-th training iteration of the N training iterations during the training task.

3. The computer-implemented method of claim 2, wherein determining that the at least one training iteration is overtime comprises:
obtaining a second time length based on at least one time length consumed by the work node for completing at least one historical training iteration during the training task, wherein the second time length indicates an average time length consumed by the work node for completing the at least one historical training iteration during the training task;
in response to determining that a difference between the first time length and the second time length is equal to or greater than a first time threshold, determining that the at least one training iteration is overtime.

4. The computer-implemented method of claim 2, wherein determining that the at least one training iteration is overtime comprises:
based on the historical iteration time length information of the work node performing the training task, determining a maximum time length among time lengths consumed by the work node for completing first to (N-1)-th training iterations of the N training iterations;
in response to that a difference between the first time length and the maximum time length is equal to or greater than a second time threshold, determining that the at least one training iteration is overtime.

5. The computer-implemented method of claim 1, wherein the at least one training iteration comprises K continuous training iterations, and
wherein determining that the at least one training iteration is overtime comprises:
obtaining a third time length consumed by the work node for continuously completing the K continuous training iterations;
obtaining an average time length consumed by the work node for continuously completing K historical training iterations of the training task;
in response to that a difference between the third time length and the average time length is equal to or greater than a third time threshold, determining the at least one training iteration is overtime.

6. The computer-implemented method of claim 1, wherein the work node and the service node both are physical nodes.

7. The computer-implemented method of claim 1, configured to be performed by a second server,
wherein one of the work node and the service node is a virtual machine running on a third server, and the other one of the work node and the service node is a physical node or a virtual machine running on a fourth server.

8. The computer-implemented method of claim 1, configured to be performed by a first virtual machine on a second server,
wherein the second server is configured to further run a second virtual machine and a third virtual machine, the second virtual machine being functioned as the work node, the third virtual machine being functioned as the service node.

9. The computer-implemented method of claim 1, further comprising:
before obtaining the time information, running a training task startup script to obtain a time length consumed by the work node to complete at least one training iteration during the training task.

10. The computer-implemented method of claim 9, wherein the training task startup script comprises at least one of
information for determining whether the at least one training iteration is overtime or
a preset bandwidth adjustment amplitude.

11. The computer-implemented method of claim 1, further comprising:
obtaining a current first bandwidth of the service node; and
based on the current first bandwidth and a preset bandwidth adjustment amplitude, determining to adjust the bandwidth of the service node to a second bandwidth,
wherein the second bandwidth is greater than the current first bandwidth and is carried in the bandwidth update request.

12. An apparatus, comprising:
at least one processor; and
one or more memories coupled to the at least one processor and storing programming instructions for execution by the at least one processor to perform operations comprising:
obtaining time information for a work node completing at least one training iteration during a training task; and
in response to determining, based on the time information, that the at least one training iteration is overtime, sending a bandwidth update request to a first server, wherein the bandwidth update request indicates a request for the first server to update a bandwidth of a service node which stores data of the training task.

13. The apparatus of claim 12, wherein the at least one training iteration comprises N training iterations, and wherein determining that the at least one training iteration is overtime comprises:
based on a first time length consumed by the at least one training iteration and historical iteration time length information of the work node performing the training task, determining the at least one training iteration is overtime, wherein the first time length indicates a time consumed by the work node for completing an N-th training iteration of the N training iterations during the training task.

14. The apparatus of claim 13, wherein determining that the at least one training iteration is overtime comprises:
obtaining a second time length based on at least one time length consumed by the work node for completing at least one historical training iteration during the training task, wherein the second time length indicates an average time length consumed by the work node for completing at least one historical training iteration during the training task;
in response to determining that a difference between the first time length and the second time length is equal to or greater than a first time threshold, determining that the at least one training iteration is overtime.

15. The apparatus of claim 13, wherein determining that the at least one training iteration is overtime comprises:
based on the historical iteration time length information of the work node performing the training task, determining a maximum time length among time lengths consumed by the work node for completing first to (N-1)-th training iterations of the N training iterations; and
in response to determining that a difference between the first time length and the third time length is equal to or greater than a second time threshold, determining that the at least one training iteration is overtime.

16. The apparatus of claim 12, wherein the at least one training iteration comprises K continuous training iterations, and
wherein determining that the at least one training iteration is overtime comprises:
obtaining a third time length consumed by the work node for continuously completing the K training iterations;
obtaining an average time length consumed by the work node for continuously completing K historical training iterations of the training task; and
in response to determining that a difference between the third time length and the average time length is equal to or greater than a third time threshold, determining the at least one training iteration is overtime.

17. The apparatus of claim 12, wherein, before obtaining the time information for the work node completing the at least one training iteration during the training task, the operations further comprise:
running a training task startup script to obtain a time length consumed by the work node to complete the at least one training iteration during the training task.

18. The apparatus of claim 17, wherein the training task startup script comprises at least one of:
information for determining whether the at least one training iteration is overtime, or a preset bandwidth adjustment amplitude.

19. The apparatus of claim 12, wherein the operations further comprise:
obtaining a current first bandwidth of the service node; and
based on the current first bandwidth and a preset bandwidth adjustment amplitude, determining to adjust the bandwidth of the service node to a second bandwidth,
wherein the second bandwidth is greater than the first bandwidth and is carried in the bandwidth update request.

20. A non-transitory computer readable storage medium coupled to at least one processor having machine-executable instructions stored thereon that, when executed by the at least one processor, cause the at least one processor to perform operations comprising:
obtaining time information for a work node completing at least one training iteration during a training task; and
in response to determining, based on the time information, that the at least one training iteration is overtime, sending a bandwidth update request to a first server, wherein the bandwidth update request indicates a request for the first server to update a bandwidth of a service node which stores data of the training task.
